(19) United States
(12) Patent Application Publication
(10) Pub. No.: US 2026/0185345 A1
(43) Pub. Date: Jul. 2, 2026

(54) HEADER AND HANGER SYSTEM

(71) Applicant: Mars, Incorporated, McLean, VA (US)

(72) Inventor: Robert Daniel TREW, Birchwood, TN (US)

(21) Appl. No.: 19/002,088

(22) Filed: Dec. 26, 2024

(51) Int. Cl. E04B 1/19; B65G 47/61

(52) U.S. Cl. CPC E04B 1/19; B65G 47/61; E04B 2001/1993

(57) ABSTRACT

The disclosure provides a header and hanger system configured to suspend plant equipment such as a conveyor belt from a ceiling beam with minimal fabrication required on site, and with improved performance. A header assembly provides a header grip configured to be clamped to the ceiling beam. A hanger assembly provides a hanger suspended from the header grip, the hanger attaching to or otherwise supporting the plant equipment in use.

### TECHNICAL FIELD

This invention relates to a header and hanger system for suspending plant equipment such as conveyor belts, elevators or hoppers.

### BACKGROUND

Known arrangements for suspending plant equipment such as conveyor belts typically include elongate struts which are welded both to the conveyor belt supporting structure and to ceiling beams.

### BRIEF DESCRIPTION OF THE DRAWINGS

One or more embodiments of the invention will now be described, by way of example only, with reference to the accompanying drawings, in which:

FIGS. 1A and 1B provide illustrative views of two example hangers of embodiments of the invention supporting one or more conveyor belts;

FIG. 2 is an isometric view of a header and hanger system according to a first embodiment of the invention suspended from two ceiling beams;

FIG. 3 is a detail side view of a header grip and header beam of the first embodiment;

FIG. 4 is a detail isometric view of a header grip of the first embodiment in which only the first and second arms and first and second flanges are visible, to enable the mating apertures to be clearly seen;

FIG. 5 is a detail isometric view of the hanger grip and drop height adjustment mechanism of the first embodiment;

FIG. 6 is an isometric view of a header and hanger system according to a second embodiment of the invention suspended from two ceiling beams;

FIG. 7 is an isometric view of a header and hanger system according to a third embodiment of the invention suspended from two ceiling beams;

FIG. 8 is a detail isometric view of a header grip and drop height adjustment mechanism of the third embodiment;

FIG. 9 is an isometric view of a header and hanger system according to a fourth embodiment of the invention suspended from three ceiling beams;

FIG. 10 is a detail isometric view of a header grip of the fourth embodiment;

FIG. 11 is an isometric view of a header and hanger system according to a fifth embodiment of the invention suspended from a single ceiling beam;

FIG. 12 is a detail isometric view of a header grip and drop height adjustment mechanism of the fifth embodiment; and

FIG. 13 shows the header grip and drop height adjustment mechanism of FIG. 12 with the ceiling beam omitted for clarity.

### DETAILED DESCRIPTION

### Summary

The disclosure provides a header and hanger system configured to suspend plant equipment such as a conveyor belt, elevator or hopper from a ceiling beam with minimal fabrication required on site, and with improved performance. A header assembly provides a header grip configured to be clamped to the ceiling beam. A hanger assembly provides a hanger suspended from the header grip, the hanger attaching to or otherwise supporting the plant equipment in use.

A first aspect of the disclosure provides a header and hanger system configured to suspend plant equipment from a ceiling beam, the system comprising: a header assembly, including a header grip configured to clamp the header assembly to the ceiling beam; and a hanger assembly, including a hanger configured to permit connection to the plant equipment, the hanger being suspended from the header assembly.

Header and hanger systems according to the first aspect have particular advantages over prior art arrangements. In particular, minimal fabrication is required on site in the factory or plant building, leading to minimal time that the production line needs to be offline and minimal contamination of the site. This is in contrast to prior art arrangements which require all fabrication to be carried out on site. In particular, it is necessary for ceiling beams to be subjected to surface grinding or otherwise surface treated on site to expose bare metal prior to welding of suspension struts thereto. This is a disruptive and dusty operation, which requires that production is stopped and all production materials removed from the area, leading to loss of production. Moreover, header and hanger systems according to the invention provide improved performance in seismic events. The welded joints between the suspension struts of prior art arrangements and ceiling beams typically fail because of fatigue loading.

The ceiling beam may comprise any structural member located in, on or at a ceiling of a building in which the plant equipment is to be housed. For example, the ceiling beam may comprise an elongate member extending across a full or partial span of the ceiling. The ceiling beam may be configured to support the roof, ceiling or other building features. Alternatively, the ceiling beam may be configured to support equipment such as an overhead gantry crane or other plant equipment.

The ceiling beam may have an I-shaped cross-section. Alternatively, the ceiling beam may comprise a closed box section form with a square or rectangular cross-section, or an open box section form with a U-shaped or L-shaped cross-section.

The header grip is preferably configured to releasably clamp the header assembly to the ceiling beam. In this way, the header grip can be readily clamped to the header assembly with minimal off-line time for the plant equipment, and minimal contamination of the site. Moreover, subsequent removal or movement of the header and hanger system can also be minimally disruptive.

The hanger may be configured in many different forms. The hanger supports the plant equipment so that it is suspended beneath the header grip.

The header assembly preferably includes a header beam and the header grip is preferably configured to releasably clamp the header beam to the ceiling beam so that the header beam extends generally laterally, the hanger assembly being movable along the header beam to permit suspension of the hanger at a plurality of positions laterally along the header beam.

This arrangement enables the plant equipment to be suspended at positions other than directly beneath a ceiling beam, and thus provides for particular flexibility. In preferred arrangements the position of the hanger assembly along the header beam can be continuously or progressively adjusted to any position along a length of the header beam.

In such embodiments the header assembly preferably includes a further header grip configured to releasably clamp the header beam to a further ceiling beam. Thus, the plant equipment can be suspended from a position between the ceiling beam and further ceiling beam.

The hanger assembly preferably comprises a hanger grip configured to clamp the hanger to the header beam so that the hanger is suspended from the header beam. The hanger grip can be configured to releasably clamp the hanger to the header beam. This arrangement provides for adjustment of the position of the hanger assembly on site with minimal fabrication and consequential disruption. By clamping the hanger to the header beam, unwanted movement of the hanger assembly (and therefore the plant equipment) relative to the header assembly is minimised.

The header beam preferably has first and second elongate faces that meet at an uppermost position, and the header grip is configured so that the first and second elongate faces slope away from the uppermost position. This arrangement prevents dust and other undesirable contaminants from accumulating on the header beam, and also provides for a particularly stable means of suspending the hanger.

The hanger is preferably suspended from a single suspension location on the header assembly, and/or is preferably configured to be connected to the plant equipment at two or more locations. This arrangement provides for particularly good performance in the event of seismic activity or other events that may lead to swaying motion of the suspended plant equipment.

For example, in embodiments in which the plant equipment comprises apparatus such as a conveyor belt supported by a lateral beam, the hanger is preferably configured to be connected to a first location at a first end of the lateral beam and a second location at a second end of the lateral beam. Preferably, the hanger comprises a drop arm suspended from the header assembly, a first arm member extending from the drop arm to the first location, and a second arm member extending from the drop arm to the second location, the apparatus being located between the first arm member and second arm member in use. The drop arm may connect at a lower end to a cross-member which in turn connects upper portions of the first and second arm members. For example, the apparatus may be encircled by the lateral beam, cross-member, first arm member and second arm member in use.

In some embodiments, the plant equipment may comprise a first apparatus such as a first conveyor belt supported by a first lateral beam and a second apparatus such as a second conveyor belt supported by a second lateral beam suspended beneath the first lateral beam. In such embodiments, the hanger is preferably configured to be connected to first locations at first ends of the first lateral beam, and to second locations at second ends of the second lateral beam. Preferably, the hanger comprises a drop arm suspended from the header assembly, a first arm member extending from the drop arm to the first locations, and a second arm member extending from the drop arm to the second locations, the first and second apparatus being located between the first arm member and second arm member in use. The drop arm may connect at a lower end to a cross-member which in turn connects upper portions of the first and second arm members. For example, the first apparatus may be encircled by the first lateral beam, cross-member, first arm member and second arm member in use. Similarly, the second apparatus may be encircled by the first lateral beam, second lateral beam, first arm member and second arm member in use

The hanger assembly preferably comprises a drop height adjustment mechanism configured to alter a distance between the header assembly and the hanger in use. This arrangement enables a position of the plant equipment to be fine-tuned during assembly.

Preferably, the drop height adjustment mechanism comprises an aperture, a threaded rod, and a threaded nut, the threaded rod having a first end affixed to the hanger and a second end passing through the aperture and mating with the threaded nut, whereby turning of the nut causes a distance between the aperture and the hanger to change. The aperture may be provided in a plate-like member, for example a laterally-extending plate-like member.

The drop height adjustment mechanism preferably comprises a first tube-like housing enclosing the threaded rod. This arrangement prevents dust or other contaminants from collecting on the threads of the threaded rod during use. The aperture may be provided in a cap member or other plate-like member concealing an upper opening of the first tube-like housing.

The hanger, for example the drop arm of the hanger, comprises a second closed tube-like member configured to nest with the first closed tube-like member to permit relative movement therebetween. This arrangement provides for a particularly efficient means of preventing the accumulation of dust and other contaminants within the drop height adjustment mechanism during use, and also provides improved rigidity of the hanger.

The header grip preferably comprises first and second arms, the first arm being movable relative to the second arm to permit the ceiling beam to be accommodated therebetween. For example, a joint may connect the first and second arms, unfastening of the joint permitting relative movement between the first and second arms, for example during assembly, and fastening of the joint preventing such relative movement, for example after assembly.

The one or more header grips may each comprise a connecting member having an unfastened configuration in which movement of the first arm relative to the second arm is permitted, and a fastened configuration in which the connecting member is connected between the first and second arms to resist relative movement therebetween.

In embodiments in which the header assembly includes a header beam and the header grip is configured to releasably clamp the header beam to the ceiling beam so that the header beam extends generally laterally, the first arm and/or the second arm may comprise a connecting member extending laterally therefrom, the connecting member having at least one mating face mating with an exterior face of the header beam.

The connecting member may comprise one or more fastener apertures for a fastener to pass therethrough to secure the header grip to the header beam. The header assembly may comprise one or more fasteners passing through the one or more fastener apertures, respectively, to thereby secure the header grip to the header beam. In methods according to the invention, one or more corresponding fastener apertures may be formed in the header beam during installation, and one or more fasteners fastened therethrough to secure the header grip to the header beam.

The header grip preferably comprises first and second arms, and first and second flanges extending towards each other from the first and second arms, respectively, the first and second flanges engaging the ceiling beam in use. The header and hanger assembly is thus suspended via the first and second flanges in use.

The header assembly may comprise an offset member configured to be secured between the first flange or second flange and the ceiling beam to provide an offset therebetween in use. The offset member enables the header and hanger system to accommodate plant systems such as conduit, cabling or piping that is routed across, on or along the ceiling beam, or patch repair plates or other structural members located on the ceiling beam. The offset member preferably comprises an opening, through hole or other passageway for routing conduit, pipes or cabling therethrough.

In some embodiments, the header grip may comprise one or more stabilising assemblies configured to secure the header grip to the ceiling beam. The one or more stabilising assemblies may comprise a set screw or grub screw operable to be urged against the ceiling beam to provide a particularly secure connection between the header grip and the ceiling beam. For example, the header grip may comprise a threaded aperture and a mating set screw movable within the threaded aperture to enable a tail of the set screw to be urged against the ceiling beam in use. This arrangement provides for particular stability during seismic events or other events in which undesired motion of the suspended plant machinery may occur.

A second aspect of the disclosure provides a method of suspending plant equipment from a ceiling beam using the header and hanger system of the first aspect, the method including the steps of: clamping the header assembly to the ceiling beam; and connecting the hanger to the plant equipment.

The plant equipment preferably comprises a conveyor belt supported by a lateral beam, and the method includes connecting the hanger to a first location at a first end of the lateral beam and to a second location at a second end of the lateral beam

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect or embodiment of the disclosure may be as described in connection with any of the other aspects or embodiments. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. In particular, any features of the disclosed embodiments can be applied to the aspects, clauses or claims.

### Embodiments

The embodiments illustrate header and hanger systems for suspending one or more conveyor belts 100 from one or more ceiling beams 120 of a plant building via a hanger 50.

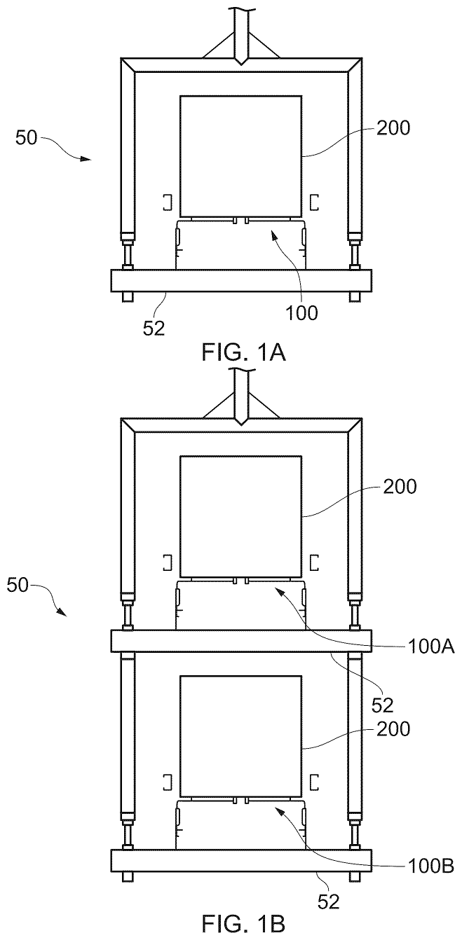

As illustrated in FIGS. 1A and 1B, each hanger 50 may support a single conveyor belt 100 for carrying containers 200, or a deck of two or more such conveyor belts 100 arranged in a stack so that an upper conveyor belt 100A is located above a lower conveyor belt 100B. The skilled reader will understand that the particular configuration of the conveyor belts 100 is directed by the specific nature of the plant operations, and that the illustrated configurations are merely examples. The skilled reader will also recognise that the header and hanger systems disclosed herein are suitable for suspending other plant equipment from one or more ceiling beams 120 of a plant building. For example, a hopper or elevator may be suspended using header and hanger systems according to embodiments of the invention.

The illustrated ceiling beams 120 are I-beams with an I-shaped cross-section, and the embodiments are configured to interface with this particular beam configuration. However, the skilled reader will recognise that the embodiments may be readily modified without departing from the inventive concept in order to accommodate other configurations of ceiling beam. For example, the disclosure encompasses arrangements in which the header and hanger system is suspended from a ceiling beam having a closed box section form with a square or rectangular cross-section, or an open box section form with a U-shaped or L-shaped cross-section.

In the illustrations, the ceiling beams 120 are shown truncated for clarity. The skilled reader will understand that the ceiling beams 120 will usually be elongate members, spanning a whole or partial ceiling region.

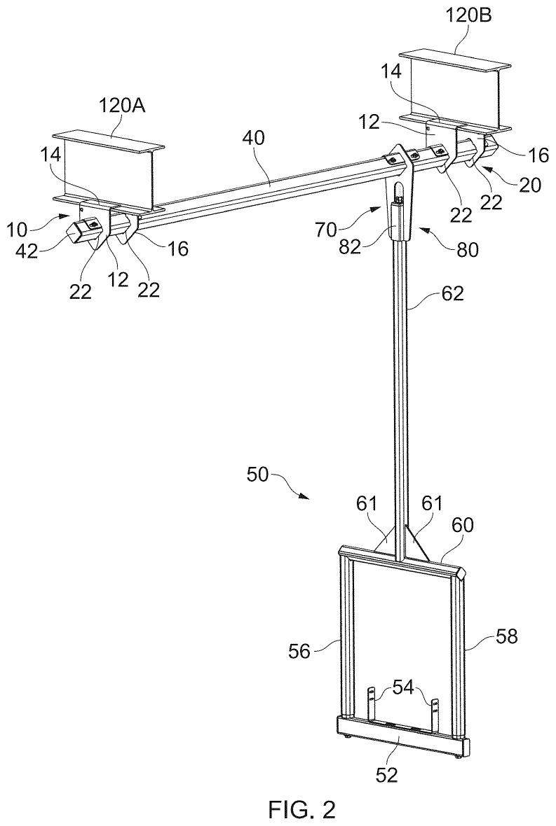

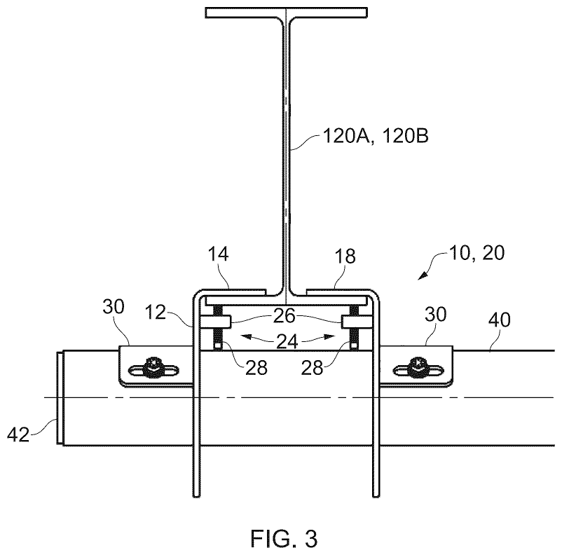

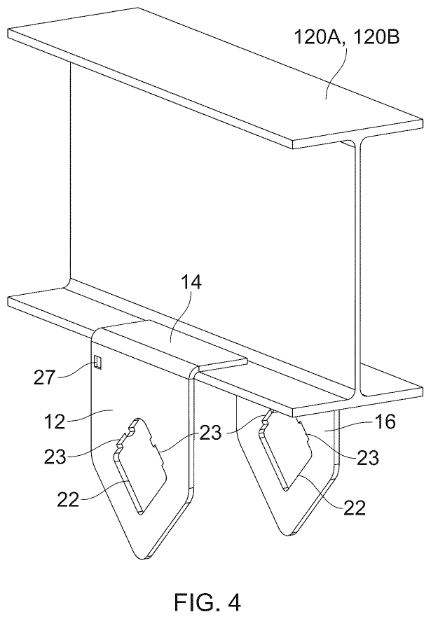

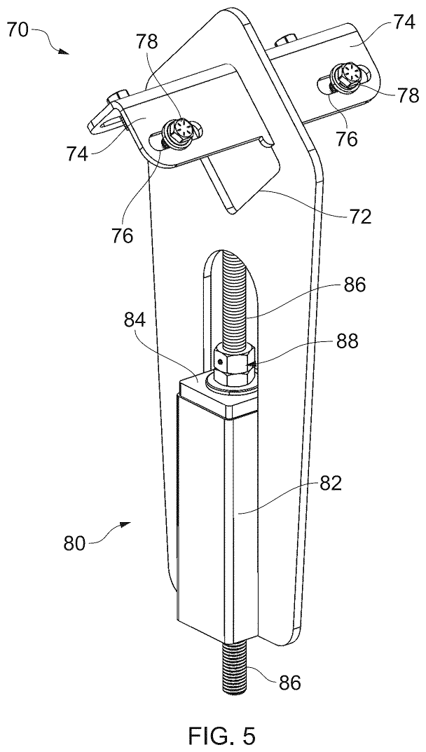

A first embodiment of a header and hanger system is illustrated in FIGS. 2 to 5. The system comprises a hanger 50 configured to accommodate a single conveyor belt (not shown), but the skilled reader will understand that the hanger 50 may be modified to accommodate two or more conveyor belts, or to accommodate alternative plant equipment such as a hopper or elevator, or other equipment suspended from a ceiling.

The conveyor belt (not shown) is supported by a lateral beam 52 carrying support brackets 54 to which a support system of the conveyor belt is attached. The hanger 50 comprises first 56 and second 58 arm members extending upwardly from first and second ends of the lateral beam 52 so that the conveyor belt is located between the first 56 and second 58 arm members in use. A cross-member 60 connects upper ends of the first 56 and second 58 arm members, and a drop arm 62 supports the cross-member 60 so that the first 56 and second 58 arm members are suspended therefrom. Shear webs are preferably provided between the cross-member 60 and the drop arm 62 to transmit bending loads between the lateral beam 52 and the drop arm 62 and thereby prevent unwanted pivoting of the lateral beam 52 relative to the drop arm 62.

The system 100 is suspended from two ceiling beams 120A, 120B. A first header grip 10 is releasably clamped to a first of the ceiling beams 120A, and a second header grip 20 is releasably clamped to a second of the ceiling beams 120B. An elongate header beam 40 extends generally laterally between the first 10 and second 20 header grips.

The header beam 40 is arranged so that its upwardly-facing faces are sloped away from an uppermost region thereof. This arrangement prevents dust and other undesirable contaminants from accumulating on the header beam, and also provides for a particularly stable suspension means, as will be described further below. In the illustrated arrangement, the header beam 40 has a generally square-shaped cross-section, and is arranged so that one of its corner edges forms an uppermost apex. In preferred embodiments the header beam 40 has a generally tubular form to minimise weight and material costs. In such arrangements open ends of the header beam 40 are closed by end caps 42 to prevent the accumulation of dust and other undesirable contaminants therein.

Each of the first 10 and second 20 header grips comprises a first arm 12 with a first flange 14 and a second arm 16 with a second flange 18. The first 14 and second 18 flanges extend generally laterally towards one another to engage a lower flange of the respective ceiling beam 120A, 120B. The first 14 and second 18 flanges of the first 10 and second 20 header grip 20 directly engage the lower flange of the respective ceiling beam 120A, 120B so that there is a direct mating contact between faces thereof to provide for efficient load transfer.

The first arm 12 and the second arm 16 of the first 10 and second 20 header grips comprise mating apertures 22 through which the header beam 40 passes. The mating apertures 22 are shaped to correspond to a cross-sectional shape of the header beam 40. The mating apertures 22 provide a close fit with external faces of the header beam 40 to permit sliding of the header beam 40 therein during assembly, yet securely locate the header beam 40 in the desired orientation, and to prevent unwanted rotation thereof.

The first 10 and second 20 header grips each comprise a pair of connecting members 30 extending from the first 12 and second 16 arms, respectively, from a region adjacent the mating apertures 22. The connecting members 30 extend generally laterally, and in an opposing direction to the first 14 and second 18 flanges, respectively. The connecting members 30 have one or more mating faces that have a direct mating contact with one or more external faces of the header beam 40 to provide a particularly secure connection between the header beam 40 and the first 10 and second 20 header grips. In the illustrated embodiments the connecting members 30 have a generally L-shaped configuration having mating faces configured to enable a close mating fit with an exterior of the header beam 40.

The connecting members 30 are each rigidly connected to the respective first 12 or second 16 arm, for example via a welded joint. In preferred arrangements the connecting members 30 each comprise one or more projections that mate with one or more corresponding recesses 23 at a periphery of the mating apertures 22, to enable a particularly secure welded joint to be formed. The connecting members 30 each comprise a pair of slotted fastener holes 32. During assembly, once the header grips 10, 20 have been clamped to the ceiling beams 120A, 120B, and the header beam 40 has been located relative to the header grips 10, 20, the slotted fastener holes 32 are used as a guide to enable corresponding holes to be drilled into the header beam 40, and fasteners 34 fastened therethrough to thereby secure the header beam 40 to the header grips 10, 20.

First and second stabilising assemblies 24 secure the first 14 and second 18 flanges to the respective ceiling beam 120A, 120B. Each stabilising assembly 22 comprises a mounting member 26 extending from each of the first 12 and second 16 arms of the header grip 10, 20 in a corresponding direction to the first 14 and second 18 flanges, respectively. Each mounting member 26 has a threaded aperture accommodating a threaded set screw 28. Movement of the set screw within the threaded aperture causes a tail of the set screw 28 to be urged against the ceiling beam 120A, 120B to thereby secure the first 14 and second 18 flanges to the respective ceiling bean 120A, 120B. The mounting members 26 are preferably welded to the first 12 and second 16 arms. In particularly preferred arrangements, each mounting member 26 comprises a projection that extends into a corresponding recess 27 in the respective first 12 or second 16 arm, to enable a particularly secure welded joint to be formed.

The hanger 50 is suspended from the header beam 40 by a hanger grip 70, to which the drop arm 62 of the hanger 50 is connected. During installation, the hanger grip 70 is movable in a continuous manner along the header beam 40 to ensure that the hanger 50 is located in an optimal position for suspension of the conveyor belt.

The hanger grip 70 comprises a main body having a mating aperture 72 shaped to correspond to a cross-sectional shape of the header beam 40, in a similar manner to the mating apertures 22 of the header grips 10, 20. The mating aperture 72 provides a close fit with external faces of the header beam 40 to permit sliding of the hanger grip 70 in a continuous manner along the header beam 40 during assembly, yet securely locate the hanger grip 70 in the desired orientation, and to prevent unwanted rotation thereof.

The hanger grip 70 comprises a pair of connecting members 74 extending in opposing directions from a region of the main body adjacent the mating aperture 72. The connecting members 74 have one or more mating faces that have a direct mating contact with one or more external faces of the header beam 40 to provide a particularly secure connection between the header beam 40 and the hanger grip 70. In the illustrated embodiments the connecting members 74 have a generally L-shaped configuration having mating faces configured to enable a close mating fit with an exterior of the header beam 40.

The connecting members 74 each comprise a pair of slotted fastener holes 76. During assembly, once the hanger grip 70 has been positioned at the desired location relative to the header beam 40, the slotted fastener holes 76 are used as a guide to enable corresponding holes to be drilled into the header beam 40, and fasteners 78 fastened therethrough to thereby secure the hanger grip 70 to the header beam 40.

A drop height adjustment mechanism 80 enables a distance between the hanger grip 70 and the hanger 50 to be adjusted, to thereby provide for fine tuning of the hanger 50 position during assembly. The drop height adjustment mechanism 80 comprises a tube-like housing 82 rigidly connected to the main body of the hanger grip 70 so that it is in an upright orientation, i.e. it extends generally vertically in use. The tube-like housing 82 is capped at a top face thereof by a cap plate 84 with an aperture therein. A threaded rod 86 is enclosed by the tube-like housing 82 so that it passes through the aperture. A lower end of the threaded rod 86 is connected to the drop arm 62 of the hanger 50, and a locking nut assembly 88 is threaded onto an upper end of the threaded rod 86 so that the cap plate 84 is located between the locking nut assembly 88 and the drop arm 62. In this way, movement of the locking nut assembly 88 along the threaded rod 86 causes the drop arm 62 to be moved closer to the hanger grip 70 or further away from the hanger grip 70, as needed.

The locking nut assembly 88 may comprise any suitable form of locking nut, lock nut, self-locking nut, stiff nut or other type of nut that is configured to resist loosening under torque or vibration. The locking nut assembly 80 preferably includes a washer to distribute loads from the nut(s) to the cap plate 84.

The tube-like housing 82 of the drop height adjustment mechanism 80 is preferably open at its lower face. The drop arm 62 comprises a tube-like member that is preferably configured to nest within the tube-like housing 82 so as to be movable within as the drop height adjustment mechanism 80 is operated. In this way, at least a majority of the threaded rod 86 is concealed by the tube-like housing 82 and the drop arm 62, to prevent dust and other undesirable contaminants accumulating thereon. In addition, an exterior of the tube-like member of the drop arm 62 is preferably configured to provide a close fit with an interior of the tube-like housing 82 of the drop height adjustment mechanism 80 to ensure transfer of torque loads between the hanger 50 and the hanger grip 70, and prevent undesirable rotational movement therebetween. An additional securing mechanism (not shown) may be provided to further prevent unwanted relative rotational movement between the hanger 50 and hanger grip 70.

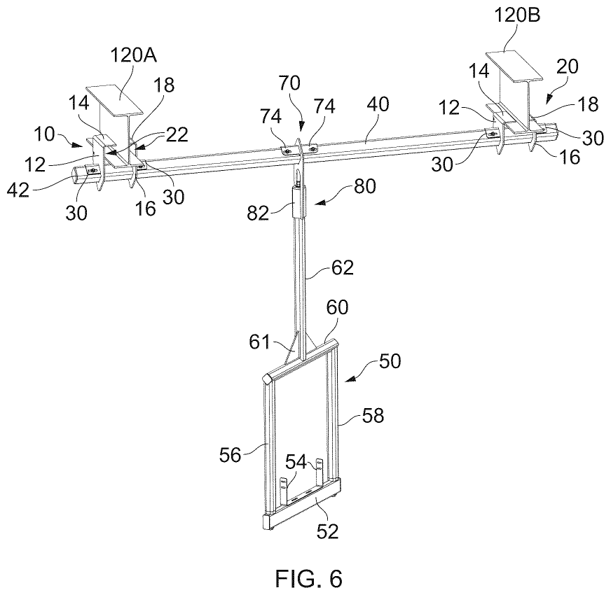

FIG. 6 illustrates a modified version of the header and hanger system of the first embodiment, in which like features are identified by like reference numerals. Only the features that differ will be described here, the skilled reader understanding that the description above should be applied to this second embodiment in all other respects.

The header and hanger system is modified to accommodate plant systems such as conduit, cabling or piping that is routed across the lower flange of the first ceiling beam 120A, or patch repair plates or other structural members located on the lower flange of the first ceiling beam 120A.

In contrast to the first 14 and second 18 flanges of the second header grip 20, the first 14 and second 18 flanges of the first header grip 10 are offset from the lower flange of the first ceiling beam 120A so that there is an offset gap 22 therebetween. This offset gap 22 is provided to accommodate the plant systems or structural members described above. An offset member (not shown) is located in the offset gap 22 to provide for load transfer between the first 14 and second 18 of the first header grip 10 and the lower flange of the first ceiling beam 120A, the offset member having an aperture or other open space through which the plant systems are routed, or via which the repair features are accommodated. Suitable forms for the offset member include a member having an open cross-section such as a C-shaped or L-shaped cross section.

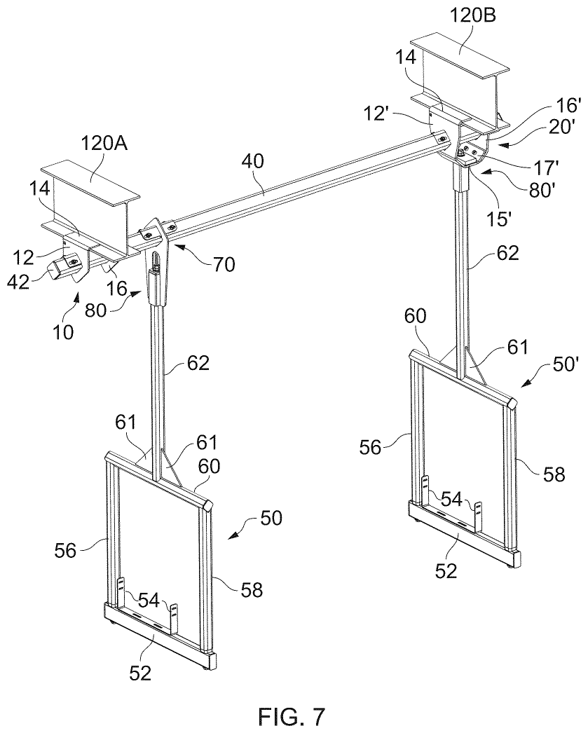

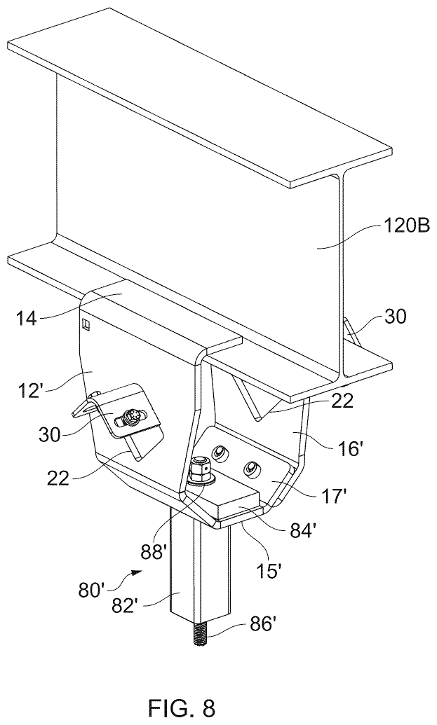

FIGS. 7 and 8 illustrate another modified version of the header and hanger system of the first embodiment, in which like features are identified by like reference numerals. Only the features that differ will be described here, the skilled reader understanding that the description above should be applied to this third embodiment in all other respects.

The header and hanger system is modified to provide a second hanger 50′ suspended from a modified second header grip 20′. This arrangement enables the second hanger 50′ to be suspended directly beneath the second ceiling bean 120B, while the hanger 50 is suspended from the header beam 40 at a position between the first 120A and second 120B ceiling beams via the hanger grip 70. This provides particular flexibility for the positioning of hangers to ensure that each of the hanger 50 and the second hanger 50′ is located in an optimal position for suspension of the conveyor belt. The second hanger 50′ is identical to the hanger 50.

The second header grip 20′ has modified first 12′ and second 16′ arms, but the first 14 and second 18 flanges, connecting apertures 22, and connecting members 30 have corresponding features to those of the first header grip 10. The first 12′ and second 16′ arms are connected at lower regions thereof to a base member 15′ to form a generally U-shaped member, the first arm 12′ forming one of the limbs of the U and the second arm 16′ forming the other of the limbs. In the illustrated embodiment the base member 15′ is formed integrally with the first arm 12′ and the second arm 16′ is connected thereto via a fastened joint 17′ to enable relative movement between the first 12′ and second 16′ arms to permit the second ceiling beam 120B to be accommodated therebetween. In other embodiments, an alternative means may be provided for enabling relative movement between the first 12′ and second 16′ arms.

The second hanger 50′ is connected to the base member 15′ of the second header grip 20′ via a modified drop height adjustment mechanism 80′, which enables a distance between the modified header grip 20′ and the second hanger 50′ to be adjusted, to thereby provide for fine tuning of the second hanger 50′ position during assembly. The drop height adjustment mechanism 80′ comprises a tube-like housing 82′ rigidly connected to the base member 15′ of the second header grip 20′ so that it is upright, i.e. it extends generally vertically in use. The tube-like housing 82′ is capped at a top face thereof by a cap plate 84′ with an aperture therein. A threaded rod 86′ is enclosed by the tube-like housing 82′ so that it passes through the aperture. A lower end of the threaded rod 86′ is connected to the drop arm 62 of the second hanger 50′, and a locking nut assembly 88′ is threaded onto an upper end of the threaded rod 86′ so that the cap plate 84′ is located between the locking nut assembly 88′ and the drop arm 62. In this way, movement of the locking nut assembly 88′ along the threaded rod 86′ causes the drop arm 62 to be moved closer to the second header grip 20′ or further away from the second header grip 20′, as needed.

The locking nut assembly 88′ may comprise any suitable form of locking nut, lock nut, self-locking nut, stiff nut or other type of nut that is configured to resist loosening under torque or vibration. The locking nut assembly 88′ preferably includes a washer to distribute loads from the nut(s) to the cap plate 84.

The tube-like housing 82′ of the drop height adjustment mechanism 80′ is preferably open at its lower face. The drop arm 62 comprises a tube-like member that is preferably configured to nest within the tube-like housing 82′ so as to be movable within as the drop height adjustment mechanism 80′ is operated. In this way, at least a majority of the threaded rod 86′ is concealed by the tube-like housing 82′ and the drop arm 62, to prevent dust and other undesirable contaminants accumulating thereon. In addition, an exterior of the tube-like member of the drop arm 62 is preferably configured to provide a close fit with an interior of the tube-like housing 82′ of the drop height adjustment mechanism 80′ to ensure transfer of torque loads between the second hanger 50′ and the second header grip 20′, and prevent undesirable rotational movement therebetween. An additional securing mechanism (not shown) may be provided to further prevent unwanted relative rotational movement between the second hanger 50′ and the second header grip 20′.

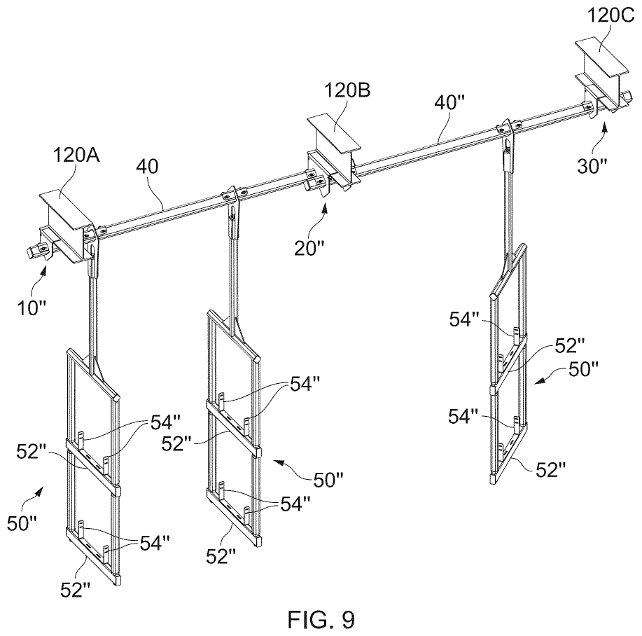

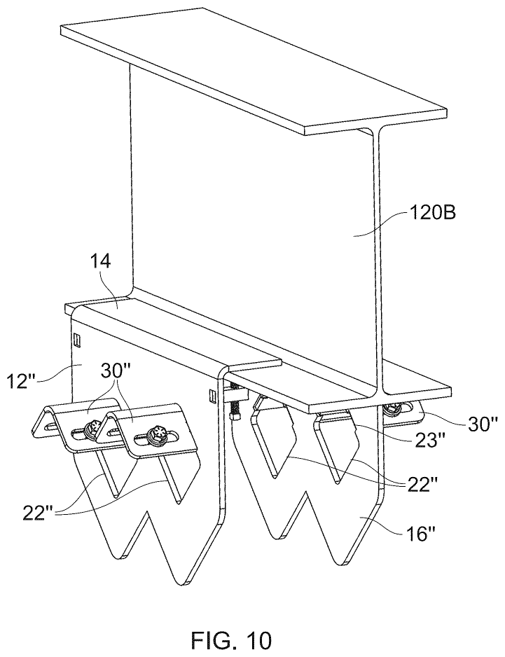

FIGS. 9 and 10 illustrate another modified version of the header and hanger system of the first embodiment, in which like features are identified by like reference numerals. Only the features that differ will be described here, the skilled reader understanding that the description above should be applied to this fourth embodiment in all other respects.

The header and hanger system is modified to provide three hangers 50″, each of which is identical to the hanger 50 of the first embodiment with the exception that each hanger 50″ is adapted to suspend a double deck of two conveyor belts (not shown) supported by two lateral beams 52″, respectively. The hangers 50″ are arranged in a series and configured to enable the supported conveyor belts to navigate a turn. That is, the conveyor belts travel in a straight line between the leftmost and middle hangers 50″ (when viewed in FIG. 9), and then change direction between the middle and rightmost hangers 50″.

The header and hanger system is suspended from first 120A, second 120B and third 120C ceiling beams by first 10″, second 20″ and third 10″ header grips. The first and third header grips 10″ are identical to one another and to the first header grip 10 of the first embodiment. The second header grip 20″ is similar to the first 10 and second 20 header grips of the first embodiment, but modified to support both the header beam 40 and a second header beam 40″. The header beam 40 and second header beam 40″ are identical to the header beam of the first embodiment.

The second header grip 20″ has modified first 12″ and second 16″ arms, connecting apertures 22″, and connecting members 30″, but the first 14 and second 18 flanges have corresponding features to those of the first header grip 10 of the first embodiment.

In particular, each of the first arm 12″ and the second arm 16″ of the second header grip 20″ comprises two mating apertures 22″, including a first mating aperture 22″ through which the header beam 40 passes and a second mating aperture 22″ through which the second header beam 40″ passes. The first mating apertures 22″ are shaped to correspond to a cross-sectional shape of the header beam 40, and the second mating apertures 22″ are shaped to correspond to a cross-sectional shape of the second header beam 40″. The mating apertures 22″ provide a close fit with external faces of the header beam 40 and second header beam 40″, respectively, to permit sliding of the header beam 40 and second header beam 40″ therein during assembly, yet securely locate the header beam 40 and second header beam 40″ in the desired orientation and prevent unwanted rotation thereof.

Two connecting members 30″ extend from each of the first 12″ and second 16″ arms, respectively, each connecting member 30″ projecting from a region adjacent a respective one of the mating apertures 22″. The connecting members 30″ extend generally laterally, and in an opposing direction to the first 14 and second 18 flanges, respectively. The connecting members 30″ each have one or more mating faces that have a direct mating contact with one or more external faces of the header beam 40 or second header beam 40″, respectively, to provide a particularly secure connection between the header beam 40 and second header beam 40″ and the second header grip 20″. In the illustrated embodiments the connecting members 30″ have a generally L-shaped configuration having mating faces configured to enable a close mating fit with an exterior of the header beam 40 and second header beam 40″, respectively.

The connecting members 30″ are each rigidly connected to the respective first 12″ or second 16″ arm, for example via a welded joint. In preferred arrangements the connecting members 30″ each comprise one or more projections that mate with one or more corresponding recesses 23″ at a periphery of the mating apertures 22″, to enable a particularly secure welded joint to be formed. The connecting members 30″ each comprise a pair of slotted fastener holes 32″. During assembly, once the second header grip 20″ has been clamped to the ceiling beam 120B, and the header beam 40 and second header beam 40″ have been located relative to the second header grips 20″, the slotted fastener holes 32″ are used as a guide to enable corresponding holes to be drilled into the header beam 40 and second header beam 40″, and fasteners 34″ fastened therethrough to thereby secure the header beam 40 and the second header beam 40″ to the second header grip 20″.

This embodiment enables particularly fine adjustment for the location of a series of hangers 50″, for example a series of hangers not arranged in a straight line.

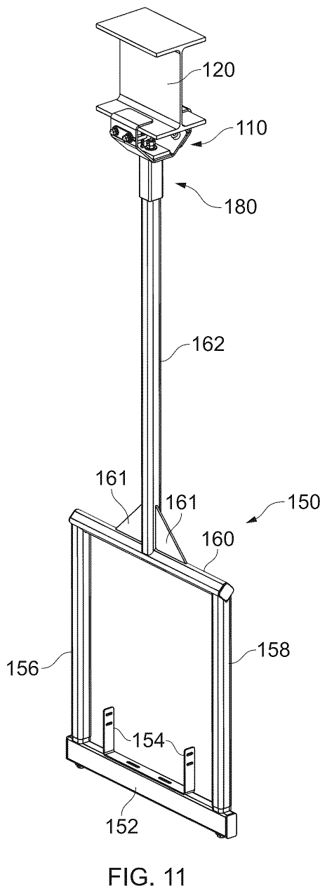

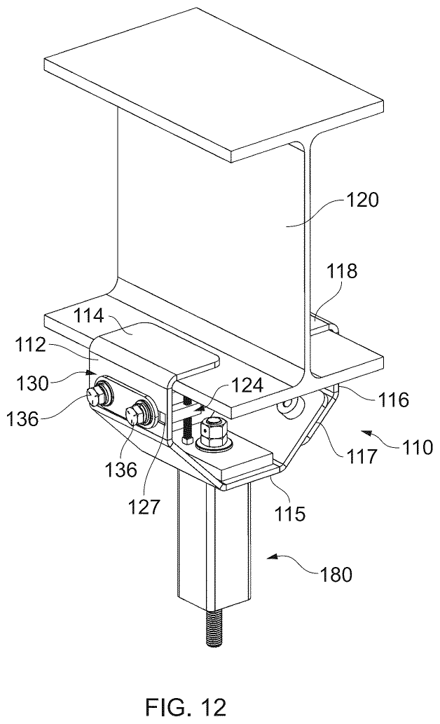

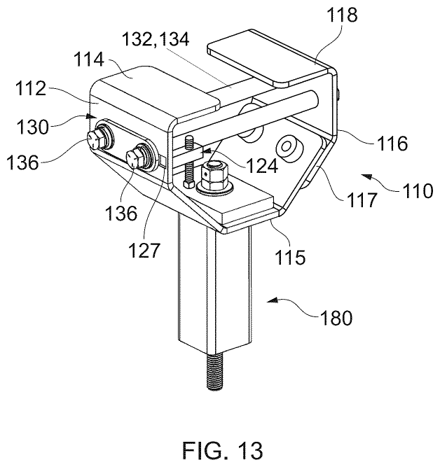

FIGS. 11 to 13 illustrate a fifth embodiment of a header and hanger system, related to the first to fourth embodiments but configured to provide for suspension of a hanger 150 directly from a ceiling beam 120 via a header grip 110 that is releasably clamped to the ceiling beam 120. This provides for a particularly neat means of locating a hanger where suspension of the conveyor belt directly beneath the ceiling beam 120 is desired.

The hanger 150 in the illustrated embodiment is configured to accommodate a single conveyor belt (not shown), but the skilled reader will understand that the hanger 150 may be modified to accommodate two or more conveyor belts, or to accommodate alternative plant equipment such as a hopper or elevator, or other equipment to be suspended from a ceiling.

The conveyor belt (not shown) is supported by a lateral beam 152 carrying support brackets 154 to which a support system of the conveyor belt is attached. The hanger 150 comprises first 156 and second 158 arm members extending upwardly from first and second ends of the lateral beam 152 so that the conveyor belt is located between the first 156 and second 158 arm members in use. A cross-member 160 connects upper ends of the first 156 and second 158 arm members, and a drop arm 162 supports the cross-member 160 so that the first 156 and second 158 arm members are suspended therefrom. Shear webs 161 are preferably provided between the cross-member 160 and the drop arm 162 to transmit bending loads between the lateral beam 152 and the drop arm 162 and thereby prevent unwanted pivoting of the lateral beam 152 relative to the drop arm 162.

The header grip 110 comprises a first arm 112 with a first flange 114 and a second arm 116 with a second flange 118. The first 114 and second 118 flanges extend generally laterally towards one another to engage a lower flange of the ceiling beam 120. The first 114 and second 118 flanges directly engage the lower flange of the ceiling beam 120 so that there is a direct mating contact between faces thereof to provide for efficient load transfer.

The first 112 and second 116 arms are connected at lower regions thereof to a base member 115 to form a generally U-shaped member, the first arm 112 forming one of the limbs of the U and the second arm 116 forming the other of the limbs. In the illustrated embodiment the base member 115 is formed integrally with the first arm 112 and the second arm 116 is connected thereto via a fastened joint 117 to enable relative movement between the first 112 and second 116 arms to permit the ceiling beam 120 to be accommodated therebetween. In other embodiments, an alternative means may be provided for enabling relative movement between the first 112 and second 116 arms.

A tension rod assembly 130 extends between the first 112 and second 116 arms to prevent relative movement therebetween in use. The tension rod assembly 130 includes a pair of tension rods 132 threaded at either end, and each sheathed by a compression tube 134 positioned between the first 112 and second 116 arms. Locking nuts 136 are applied to the threaded portions at the ends of the tension rods 132 to thereby cause the tension rods 132 to be in tension and the compression tubes 134 to be in compression, so that movement between the first 112 and second 116 arms is prevented after they have been assembled with the ceiling beam 120 in the desired location.

First and second stabilising assemblies 124 secure the first 114 and second 118 flanges to the ceiling beam 120. Each stabilising assembly 124 comprises a mounting member 126 extending from each of the first 112 and second 116 arms of the header grip 110 in a corresponding direction to the first 114 and second 118 flanges, respectively. Each mounting member 126 has a threaded aperture accommodating a threaded set screw 128. Movement of the set screw within the threaded aperture causes a tail of the set screw 128 to be urged against the ceiling beam 120 to thereby secure the first 114 and second 118 flanges to the respective ceiling bean 120. The mounting members 126 are preferably welded to the first 112 and second 116 arms. In particularly preferred arrangements, each mounting member 126 comprises a projection that extends into a corresponding recess 127 in the respective first 112 or second 116 arm, to enable a particularly secure welded joint to be formed.

A drop height adjustment mechanism 180 enables a distance between the header grip 110 and the hanger 150 to be adjusted, to thereby provide for fine tuning of the hanger 150 position during assembly. The drop height adjustment mechanism 180 comprises a tube-like housing 182 rigidly connected to the base member 115 of the header grip 110 so that it is upright, i.e. it extends generally vertically. The tube-like housing 182 is capped at a top face thereof by a cap plate 184 with an aperture therein. A threaded rod 186 is enclosed by the tube-like housing 182 so that it passes through the aperture. A lower end of the threaded rod 86 is connected to the drop arm 162 of the hanger 150, and a locking nut assembly 188 is threaded onto an upper end of the threaded rod 186 so that the cap plate 184 is located between the locking nut assembly 188 and the drop arm 162. In this way, movement of the locking nut assembly 188 along the threaded rod 86 causes the drop arm 162 to be moved closer to the header grip 110 or further away from the header grip 110, as needed.

The locking nut assembly 188 may comprise any suitable form of locking nut, lock nut, self-locking nut, stiff nut or other type of nut that is configured to resist loosening under torque or vibration during use. The locking nut assembly 188 preferably includes a washer to distribute loads from the nut(s) to the cap plate 184.

The tube-like housing 182 of the drop height adjustment mechanism 180 is preferably open at its lower face. The drop arm 162 comprises a tube-like member that is preferably configured to nest within the tube-like housing 182 so as to be movable within as the drop height adjustment mechanism 180 is operated. In this way, at least a majority of the threaded rod 186 is concealed by the tube-like housing 182 and the drop arm 162, to prevent dust and other undesirable contaminants accumulating thereon. In addition, an exterior of the tube-like member of the drop arm 162 is preferably configured to provide a close fit with an interior of the tube-like housing 82 of the drop height adjustment mechanism 180 to ensure transfer of torque loads between the hanger 150 and the header grip 110, and prevent undesirable rotational movement therebetween. An additional securing mechanism (not shown) may be provided to further prevent unwanted relative rotational movement between the hanger 150 and header grip 110.

In each of the embodiments the header grip(s), header beam(s), hanger grip(s) and hanger(s) are preferably fabricated from steel, for example using stock plate, bar and tube appropriately sized for the required loads. Parts formed from plate are preferably laser cut. Component parts are preferably welded together to form the respective header grip, header beam, hanger grip or hanger. The fabricated steel is preferably powder coated to prevent corrosion and improve hygiene.

The skilled reader will recognise that features of the illustrated embodiments can be combined in any number of ways to provide a header and hanger system suitable for a particular purpose. In particular, features of the header grip(s), header beam(s), hanger grip(s) or hanger(s) from each embodiment can be combined with features of the header grip(s), header beam(s), hanger grip(s) or hanger(s) of any of the other embodiments to provide a header and hanger system to suit a particular application. For example, the offset gap and offset member of the second embodiment can be applied to any of the header grips 20′, 10″, 20″, 30″, 110 of the third, fourth or fifth embodiments.

### Clauses

The following clauses define further aspects of the disclosure:
1. A header and hanger system configured to suspend plant equipment from a ceiling
beam, the system comprising:
   a header assembly, including a header grip configured to releasably clamp the header assembly to the ceiling beam; and
   a hanger assembly, including a hanger configured to permit connection to the plant equipment, the hanger being suspended from the header assembly.
2. A system according to clause 1, wherein the header assembly includes a header beam and the header grip is configured to releasably clamp the header beam to the ceiling beam so that the header beam extends generally laterally, the hanger assembly being movable along the header beam to permit suspension of the hanger at a plurality of positions laterally along the header beam.
3. A system according to clause 2, the header assembly including a further header grip configured to releasably clamp the header beam to a further ceiling beam.
4.A system according to clause 2 or clause 3, the hanger assembly comprising a hanger grip configured to releasably clamp the hanger to the header beam so that the hanger is suspended from the header beam.
5. A system according to any of clauses 2 to 4, wherein the header beam has first and second elongate faces that meet at an uppermost position, and the header grip is configured so that the first and second elongate faces slope away from the uppermost position.
6. A system according to any preceding clause, wherein the hanger is suspended from a single suspension location on the header assembly, and is configured to be connected to the plant equipment at two or more locations.
7. A system according to any preceding clause, wherein the plant equipment comprises apparatus such as a conveyor belt supported by a lateral beam, and the hanger is configured to be connected to a first location at a first end of the lateral beam and a second location at a second end of the lateral beam.
8. A system according to clause 7, wherein the hanger comprises a drop arm suspended from the header assembly, a first arm member extending from the drop arm to the first location, and a second arm member extending from the drop arm to the second location, the apparatus or conveyor belt being located between the first arm member and second arm member in use.
9. A system according to any preceding clause, wherein the plant equipment comprises a first apparatus such as a first conveyor belt supported by a first lateral beam, and a second apparatus such as a second conveyor belt supported by a second lateral beam, and the hanger is configured to be connected to first locations at first ends of the first lateral beam and second lateral beam, respectively, and to second locations at second ends of the first lateral beam and second lateral beam, respectively.
10. A system according to any preceding clause, wherein the hanger assembly comprises a drop height adjustment mechanism configured to alter a distance between the header assembly and the hanger in use.
11. A system according to clause 10, wherein the drop height adjustment mechanism comprises an aperture, a threaded rod, and a threaded nut, the threaded rod having a first end affixed to the hanger and a second end passing through the aperture and mating with the threaded nut, whereby turning of the nut causes a distance between the aperture and the hanger to change.
12. A system according to clause 11, wherein the drop height adjustment mechanism comprises a first tube-like housing enclosing the threaded rod.
13. A system according to clause 12, wherein the hanger comprises a second closed tube-like member configured to nest with the first closed tube-like member to permit relative movement therebetween.
14. A system according to any preceding clause, wherein the header grip comprises first and second arms, the first arm being movable relative to the second arm to permit the ceiling beam to be accommodated therebetween.
15. A system according to clause 14, wherein the one or more header grips each comprise a connecting member having an unfastened configuration in which movement of the first arm relative to the second arm is permitted, and a fastened configuration in which the connecting member is connected between the first and second arms to resist relative movement therebetween.
16. A system according to clause 14, wherein the header assembly includes a header beam and the header grip is configured to releasably clamp the header beam to the ceiling beam so that the header beam extends generally laterally, and the first arm and/or the second arm comprises a connecting member extending laterally therefrom, the connecting member having at least one mating face mating with an exterior face of the header beam.
17. A system according to clause 16, wherein the connecting member comprises one or more fastener apertures for a fastener to pass therethrough to secure the header grip to the header beam.
18. A system according to clause 17, wherein the header assembly comprises one or more fasteners passing through the one or more fastener apertures, respectively, to thereby secure the header grip to the header beam.
19. A system according to any preceding clause, wherein the header grip comprises first and second arms, and first and second flanges extending towards each other from the first and second arms, respectively, the first and second flanges engaging the ceiling beam in use.
20. A system according to clause 19, wherein the header assembly comprises an offset member configured to be secured between the first flange or second flange and the ceiling beam to provide an offset therebetween in use.
21. A system according to clause 20, wherein the offset member comprises an opening for routing pipes or cabling therethrough.
22. A system according to any preceding clause, wherein the header grip comprises a threaded aperture and a mating set screw movable within the threaded aperture to enable a tail of the set screw to be urged against the ceiling beam in use.
23. A method of suspending plant equipment from a ceiling beam using the header and hanger system of any previous clause, the method including the steps of:
   clamping the header assembly to the ceiling beam; and
   connecting the hanger to the plant equipment.
24. A method according to clause 23, wherein the plant equipment comprises apparatus such as a conveyor belt supported by a lateral beam, and the method includes connecting the hanger to a first location at a first end of the lateral beam and to a second location at a second end of the lateral beam.

What is claimed is:

1. A header and hanger system configured to suspend plant equipment from a ceiling beam, the system comprising:
a header assembly, including a header grip configured to releasably clamp the header assembly to the ceiling beam; and
a hanger assembly, including a hanger configured to permit connection to the plant equipment, the hanger being suspended from the header assembly.

2. A system according to claim 1, wherein the header assembly includes a header beam and the header grip is configured to releasably clamp the header beam to the ceiling beam so that the header beam extends generally laterally, the hanger assembly being movable along the header beam to permit suspension of the hanger at a plurality of positions laterally along the header beam.

3. A system according to claim 2, the header assembly including a further header grip configured to releasably clamp the header beam to a further ceiling beam.

4. A system according to claim 2, the hanger assembly comprising a hanger grip configured to releasably clamp the hanger to the header beam so that the hanger is suspended from the header beam.

5. A system according to claim 2, wherein the header beam has first and second elongate faces that meet at an uppermost position, and the header grip is configured so that the first and second elongate faces slope away from the uppermost position.

6. A system according to claim 1, wherein the hanger is suspended from a single suspension location on the header assembly, and is configured to be connected to the plant equipment at two or more locations.

7. A system according to claim 1, wherein the plant equipment comprises apparatus supported by a lateral beam, and the hanger is configured to be connected to a first location at a first end of the lateral beam and a second location at a second end of the lateral beam.

8. A system according to claim 7, wherein the hanger comprises a drop arm suspended from the header assembly, a first arm member extending from the drop arm to the first location, and a second arm member extending from the drop arm to the second location, the apparatus being located between the first arm member and second arm member in use.

9. A system according to claim 1, wherein the plant equipment comprises a first apparatus supported by a first lateral beam, and a second apparatus supported by a second lateral beam, and the hanger is configured to be connected to first locations at first ends of the first lateral beam and second lateral beam, respectively, and to second locations at second ends of the first lateral beam and second lateral beam, respectively.

10. A system according to claim 1, wherein the hanger assembly comprises a drop height adjustment mechanism configured to alter a distance between the header assembly and the hanger in use.

11. A system according to claim 10, wherein the drop height adjustment mechanism comprises an aperture, a threaded rod, and a threaded nut, the threaded rod having a first end affixed to the hanger and a second end passing through the aperture and mating with the threaded nut, whereby turning of the nut causes a distance between the aperture and the hanger to change.

12. A system according to claim 11, wherein the drop height adjustment mechanism comprises a first tube-like housing enclosing the threaded rod.

13. A system according to claim 12, wherein the hanger comprises a second closed tube-like member configured to nest with the first closed tube-like member to permit relative movement therebetween.

14. A system according to claim 1, wherein the header grip comprises first and second arms, the first arm being movable relative to the second arm to permit the ceiling beam to be accommodated therebetween.

15. A system according to claim 1, wherein the header grip comprises first and second arms, and first and second flanges extending towards each other from the first and second arms, respectively, the first and second flanges engaging the ceiling beam in use.

16. A system according to claim 15, wherein the header assembly comprises an offset member configured to be secured between the first flange or second flange and the ceiling beam to provide an offset therebetween in use.

17. A system according to claim 16, wherein the offset member comprises an opening for routing pipes or cabling therethrough.

18. A system according to claim 1, wherein the header grip comprises a threaded aperture and a mating set screw movable within the threaded aperture to enable a tail of the set screw to be urged against the ceiling beam in use.

19. A method of suspending plant equipment from a ceiling beam using the header and hanger system of claim 1, the method including the steps of:
clamping the header assembly to the ceiling beam; and
connecting the hanger to the plant equipment.

20. A method according to claim 19, wherein the plant equipment comprises apparatus supported by a lateral beam, and the method includes connecting the hanger to a first location at a first end of the lateral beam and to a second location at a second end of the lateral beam.
